(19) United States
(12) Patent Application Publication
(10) Pub. No.: US 2013/0316772 A1
(43) Pub. Date: Nov. 28, 2013

(54) METHOD OF PROGRESSING MOBILE BASEBALL GAME CAPABLE OF CHANGING GAME MODE

(71) Applicant: Gonggames Corp., Gyeonggi-do (KR)

(72) Inventor: Doo Sang Kong, Gyeonggi-do (KR)

(21) Appl. No.: 13/894,634

(22) Filed: May 15, 2013

(30) Foreign Application Priority Data
May 24, 2012 (KR) 20120055363

(51) Int. Cl. A63F 13/00

(52) U.S. Cl. CPC A63F 13/005
USPC 463/3

(57) ABSTRACT

The present invention relates to a method of progressing a mobile baseball game capable of changing a game mode, and more specifically, to a method of progressing a mobile baseball game capable of changing a game mode, in which when the baseball game is played at a user terminal such as a smart phone, the game mode can be selected among an owner mode in which the game is entirely progressed by artificial intelligence (AI) of a game server, a manager mode in which only details of pitching and hitting are progressed by the AI of the game server, and a player mode in which a user performs the entire handling of the game.

### CROSS-REFERENCE TO RELATED APPLICATIONS

This application claims the priority of Korean Application No. 2012-0055363, filed on May 24, 2012. The contents of the application are hereby incorporated by reference in its entirety.

### FIELD OF THE INVENTION

The present invention relates to a method of progressing a mobile baseball game capable of changing a game mode, and more specifically, to a method of progressing a mobile baseball game capable of changing a game mode, in which when the baseball game is played at a user terminal such as a smart phone, the game mode can be selected among an owner mode in which the game is entirely progressed by artificial intelligence (AI) of a game server, a manager mode in which only details of pitching and hitting are progressed by the AI of the game server, and a player mode in which a user performs the entire handling of the game.

### BACKGROUND OF THE RELATED ART

A lot of techniques for enjoying on-line network games using a PC or a smart phone are disclosed, and among the recent on-line games, strategic simulation games, first-person shooting games, fostering simulation games and the like are spotlighted. In addition, sports games such as soccer or baseball games have secured a large number of users for an extended period of time, and a baseball game that can be handled by a user himself and herself and also automatically handled by artificial intelligence, unlike a soccer game that should be continuously controlled by a user in real-time, is very popular as a PC game or a mobile game.

Particularly, as mobile terminals such as a smart phone with a wide screen are widely distributed, the number of persons enjoying on-line games regardless of time and space is increased.

FIG. 1a is a view showing a picture captured from a screen of the ‘Com2uS pro-baseball’ game serviced by Com2uS Co, FIG. 1b a view showing a picture captured from a screen of the ‘baseball degree 9’ game serviced by Naver, and FIG. 1c a view showing a picture captured from a game result posting screen of the ‘Pro-baseball manager’ game serviced by Ntreev Soft.

The ‘Com2uS pro-baseball’ is a game having the largest number of users among mobile baseball game programs, and since the game has a ‘skip’ function, it can be promptly progressed by the selection of a user.

The ‘Baseball degree 9’ is a smart phone application developed from a conventional baseball game enjoyed at a PC so as to be played even in a mobile network environment, in which a user organizes a team, selects a game schedule and sets a lineup, and if a simulation is progressed on a game screen, a result of the simulation is transmitted to the smart phone as a short message service (SMS).

The user progresses the game intervening at an appropriate level and receives a result of the game through the smart phone according to a predetermined condition.

The ‘Pro-baseball manager’ allows a user to enjoy a pro-baseball game by managing a team and players while progressing the pro-baseball game at a general PC and receiving a result of a game simulation in the form of an SMS through a cellular phone or a smart phone.

In such a mobile baseball game, a user participates in the game while viewing a simulation result of an automatically progressed baseball game, or the user progresses the baseball game while controlling motions of pitchers, batters and runners using a joystick and buttons by himself or herself.

However, in some cases, the user may desire to play a baseball game while controlling players by himself or herself, or the user may desire to set only a schedule and players and the other details of an actual game to be progressed by an AI algorithm. However, in a conventional game, the user may play the game only in one game mode since selection or change of the game mode is not allowed.

### SUMMARY OF THE INVENTION

Therefore, the present invention has been made in view of the above problems, and it is an object of the present invention to provide a method of progressing a mobile baseball game capable of changing a game mode, in which when a user connects to a game server through a user terminal and plays the mobile baseball game, a subject which handles details of the baseball game may be changed to the game server or the user according to selection of the user.

To accomplish the above object, according to one aspect of the present invention, there is provided a method of progressing a baseball game allowing a user to select a game mode, which is a degree of intervention of the user in the baseball game progressed by a game server 300, and the method includes: a first step of connecting to the game server 300 through an Internet, by a user terminal 100, when the user executes a baseball game application installed in the user terminal 100; a second step of displaying a setup window 108 for changing the game mode on a touch screen 102, by the user terminal 100, when the baseball game is started or the user presses a menu button 106 on the touch screen 102 in order to change the game mode; a third step of transmitting a game mode selection signal having information on the game mode selected by the user, by the user terminal 100, when the user selects any one game mode among an owner mode, a manager mode and a player mode from the setup window 108; a fourth step of grasping information on the game mode selected by the user from the game mode selection signal and transferring the information to a game progress module 302, by a game mode change module 306 included in the game server 300; and a fifth step of progressing the baseball game according to the game mode selected by the user and displaying a result of the baseball game on the user terminal 100, by the game progress module 302.

If the user selects the manager mode, the game progress module 302 virtually simulates pitching of a pitcher, hitting of a batter, running of a runner on a base and a motion of a fielder when the batter hits a ball according to an AI algorithm, and if the user selects the owner mode, the game progress module 302 virtually simulates pitching of a pitcher, hitting of a batter, running of a runner on a base, a motion of a fielder when the batter hits a ball, setting a strategy and directing a tactic according to the AI algorithm.

Setting a strategy includes determining substitution of a pitcher, use of a pinch hitter or adjustment of a fielding position and practicing details of the strategy in a virtual baseball game, and directing a tactic includes playing the game by setting motions of hit-and-run, a sacrifice bunt, a pickoff throw, intentional base on balls and base-stealing.

If the user selects the player mode, the user controls pitching of a pitcher, hitting of a batter, running of a runner on a base, a motion of a fielder when the batter hits a ball, setting a strategy and directing a tactic using a joystick and buttons.

### BRIEF DESCRIPTION OF THE DRAWINGS

FIG. 1a is a view showing a picture captured from a screen of the ‘Com2uS pro-baseball’ game serviced by Com2uS Co.

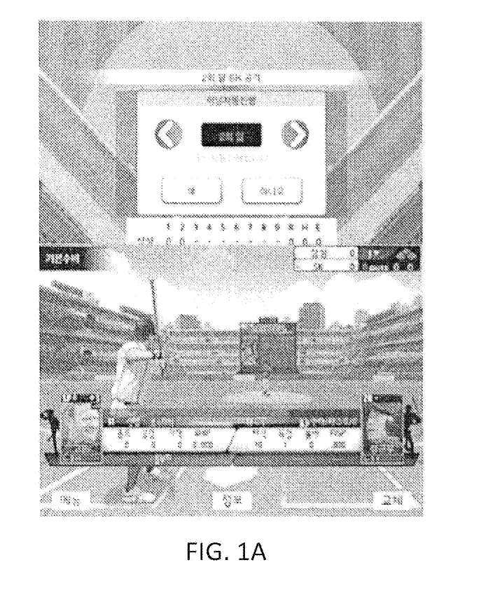

FIG. 1b a view showing a picture captured from a screen of the ‘baseball degree 9’ game serviced by Naver.

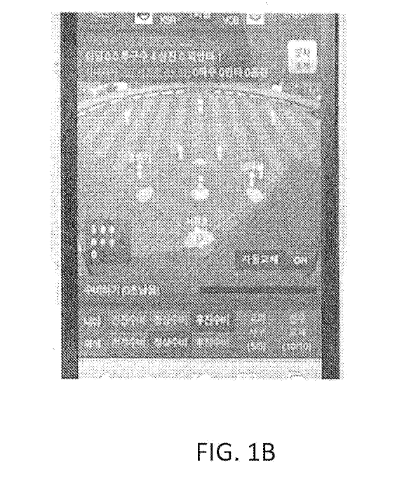

FIG. 1c a view showing a picture captured from a game result posting screen of the ‘Pro-baseball manager’ game serviced by Ntreev Soft.

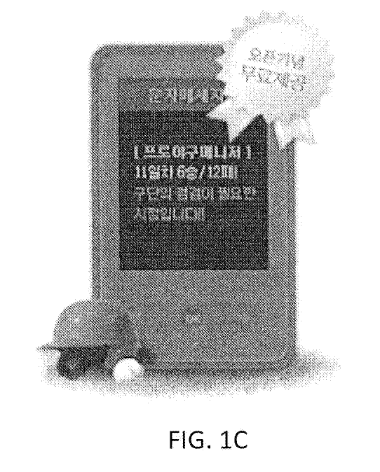

FIG. 2 is a block diagram showing the configuration and a connection state of a game server according to an embodiment of the present invention.

FIG. 3 is a conceptual view showing a method of changing a game mode in a setup window of a user terminal.

FIG. 4 is a table showing subjects which control a game in each mode.

FIG. 5 a view showing a picture captured from a game screen when an owner mode is selected.

FIG. 6 a view showing a picture captured from a game screen when a manager mode is selected.

FIG. 7 a view showing a picture captured from a game screen when a player mode is selected.

### BRIEF DESCRIPTION OF THE DRAWINGS

100: User terminal
200: Internet
300: Game server
302: Game progress module
304: Progress information DB
306: Game mode change module

### DETAILED DESCRIPTION OF THE PREFERRED EMBODIMENT

Hereafter, a method of progressing a mobile baseball game capable of changing a game mode according to an embodiment of the invention will be described with reference to the accompanying drawings.

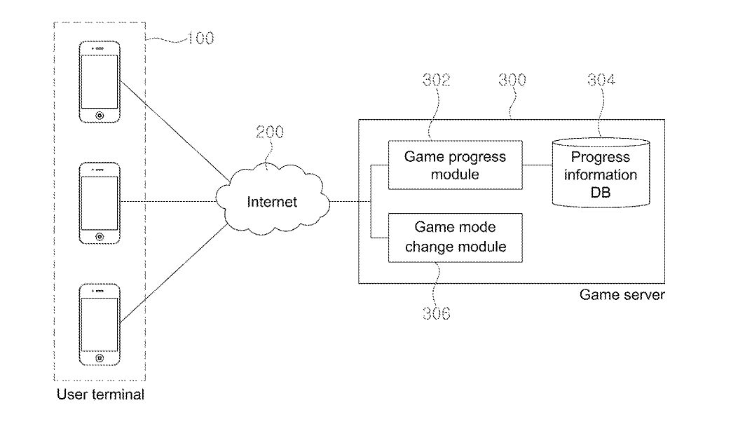

FIG. 2 is a block diagram showing the configuration and a connection state of a game server according to an embodiment of the present invention.

A user terminal 100 of the present invention is a general smart phone or tablet PC, including all the devices which use a mobile OS such as Android of Google, iOS of Apple, Symbian of Nokia, Windows 7 of MS or the like.

The user terminal 100 connects to a game server 300 through the Internet 200. Here, the Internet 200 includes all the networks connected through a mobile communication network or a WiFi wireless LAN.

The user terminal 100 includes a graphic processor for processing a baseball game. A user plays a baseball game using a virtual joystick and virtual buttons displayed on a touch screen of the user terminal 100.

The game server 300 includes a game progress module 302, a progress information DB 304 and a game mode change module 306. Although the game server 300 includes an Internet connection interface for Internet connection and a game installation program for transmitting and installing a baseball game application in the user terminal 100, such a configuration is generally included in an on-line game server, and details thereof will be omitted.

The game server 300 transmits an application installation program to the user terminal 100 so that a user may play a baseball game. In addition, the game server 300 controls the baseball game to be progressed while determining a user's handling level according to selection of the user.

When the user is in a situation unable to play a game by himself or herself or the user cannot play a game for an extended period of time, the user may progress the game by organizing a team, adjusting a schedule, changing a lineup and observing a situation of progressing the baseball game, from the viewpoint of an owner or a manager. At this point, the game server 300 progresses the baseball game based on an artificial intelligence (AI) algorithm, and the user receives only a result of the game. The game progress module 302 virtually simulates the baseball game based on game data installed in the game server 300 and transfers a result of the simulation to the user.

The user controls the game by handling input buttons of the user terminal 100 or a virtual keyboard displayed on the touch screen.

In addition, the user himself or herself may play the game while handling motions of players (pitching, hitting, running, fielding and the like). At this point, a virtual joystick and virtual buttons are displayed on the touch screen, and the user plays the game by handling them.

The AI algorithm is installed in the game progress module 302 and simulates a virtual baseball game according to data on a team selected by the user. Then, a result of the game progressed by the game progress module 302 is configured as progress information and stored in the progress information DB 304. The progress information of the game stored in the progress information DB 304 is transferred to the user terminal 100 in real-time or at regular intervals.

If the user plays the game while handling pitching and hitting by himself or herself without being dependent on the AI algorithm, the game progress module 302 stops operation of the AI algorithm and progresses the baseball game according to the handling inputted by the user.

In the present invention, a baseball game is progressed in three modes (an owner mode, a manager mode and a player mode) according to a degree of intervention of a user in the game, and a mode for playing a game is entirely determined by selection of the user. A subject which handles a game in each of the three modes provided by the game server 300 will be described below.

The game mode change module 306 grasps details of the user's selection by analyzing a game mode selection signal transmitted from the user terminal 100 and transfers the grasped information to the game progress module 302 so that a game simulation may be performed in a way desired by the user.

A result of a baseball game automatically progressed by the AI algorithm or played by direct handling of the user is created as progress information by the game progress module 302 and stored in the progress information DB 304, and the stored progress information is transmitted to the user terminal 100 as needed.

The user terminal 100 displays the progress information of the baseball game transmitted from the game server 300 on a widget or a popup window.

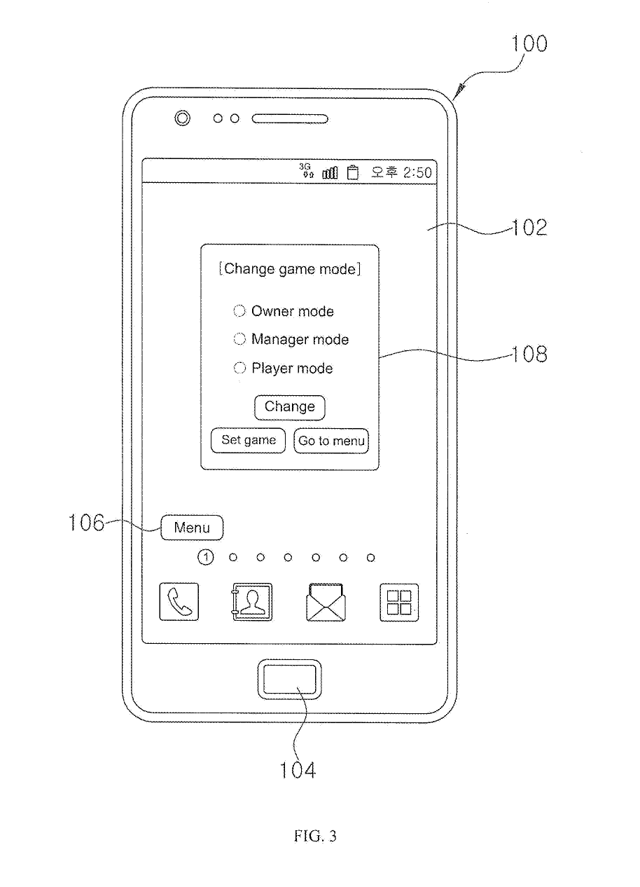

FIG. 3 is a conceptual view showing a method of changing a game mode in a setup window of a user terminal.

In order to progress a baseball game at the user terminal 100, first, an application for baseball game should be installed in the user terminal 100. If the user terminal 100 connects to the game server 300 and requests installation of the application, the game progress module 302 transmits the application to the user terminal 300 so that the application may be installed.

If the application is executed, a screen for playing the game is displayed on the touch screen 102, and when a game is started or when the user presses a menu button 106 in order to change a game mode, a setup window 108 for changing a game mode is displayed on the touch screen 102.

The menu button 106 is created on the touch screen 102 to be separated from a home button 104 of the user terminal 100, and it is preferable to display the menu button 106 within the game screen.

If the user clicks the menu button 106, the setup window 108 is displayed as shown in FIG. 3, and a list for selecting one of the owner mode, the manager mode and the player mode described above is displayed in the setup window 108. If the user selects and clicks a desired mode, information on the selection of the user is transmitted to the game server 300.

If a game mode selection signal containing the information on the mode selected by the user is transmitted to the game server 300 through the Internet 200, the game mode change module 306 grasps details of the selection of the user from the game mode selection signal. The game mode change module 306 transfers information on the mode selected by the user to the game progress module 302, and the game progress module 302 progresses a baseball game to be appropriate to the selection.

If the user selects the owner mode, the user may select only the information related to organizing a team operated by the user, and the other details of playing a game are progressed by the AI algorithm.

In addition, if the user selects the manager mode, a considerably large portion of the game progressed by the AI algorithm in the owner mode is changed to be controlled by the user.

In the case of the player mode, most of game procedures can be controlled by the user himself or herself using a joystick or buttons.

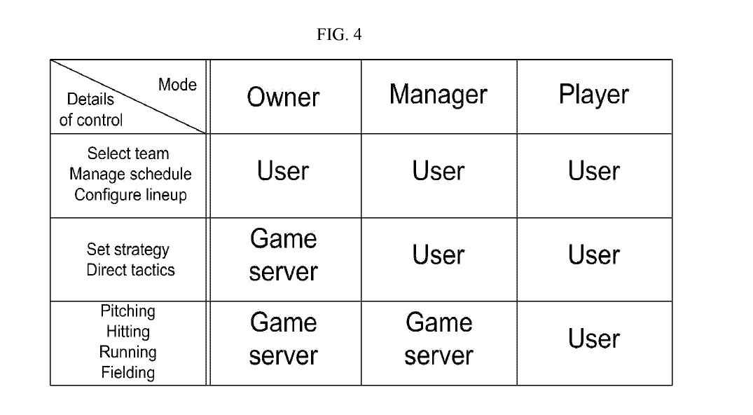

FIG. 4 is a table showing subjects which control a game in each mode, in which control subjects of important issues to be handled are shown.

Generally, a mobile baseball game program stores data on famous professional baseball leagues or international baseball games, and if a user selects a specific professional or national baseball team, the user may play games throughout a season leading the selected team. In the present invention, although the user may select any one of the three modes, the user himself or herself may select a team to operate by himself or herself, make and change a game schedule of the selected team, and set a lineup of players who will participate in a game. Accordingly, a team, a schedule and players for playing a baseball game are selected by the user.

Setting a specific strategy applied to a game while an actual baseball game is simulated and directing a tactic for offense or defense in each situation are controlled by the game server 300 based on the AI algorithm in the owner mode and controlled by the user in the manager and player modes.

Setting a strategy means determining substitution of a pitcher, use of a pinch hitter, adjustment of a fielding position or the like and practicing details of the strategy in a virtual baseball game. In addition, directing a tactic means playing a game by setting motions of hit-and-run, a sacrifice bunt of a batter, a pickoff throw or intentional base on balls of a pitcher, base-stealing or the like.

In the owner mode, setting a strategy and directing a tactic during a game are automatically performed based on a previously determined AI algorithm, and a user may view only a result the game. However, in the manager or player mode, since the user himself or herself may perform the control, the user may participate in the game further deeply.

In addition, the user may control detailed motions (pitching, hitting, running and fielding occurred in an actual baseball game) of a baseball game only in the player mode, and in the owner or manager mode, the game server 300 controls the detailed motions.

In the player mode, the user himself or herself determines a type and a course of a ball to throw by controlling pitches of a pitcher. In addition, the user controls a course and a way of hitting a ball from the viewpoint of a batter. Pitching of a pitcher and hitting of a batter are the same as those of general baseball games, and the pitching and hitting are performed at an appropriate timing by moving the cursor using a joystick.

In addition, in the player mode, the user also controls motions of fielders (catching and throwing a ball) determined as a result of hitting, and movement of runners on the bases are controlled by the user using a joystick or buttons. However, in the owner or manager mode, the motions of the fielders and the movement of the runners are automatically controlled by the AI algorithm.

There may be other types of handlings in addition to those described above, and details of the additional handlings may be appropriately added or changed according to the level of difficulty or progress status of a game.

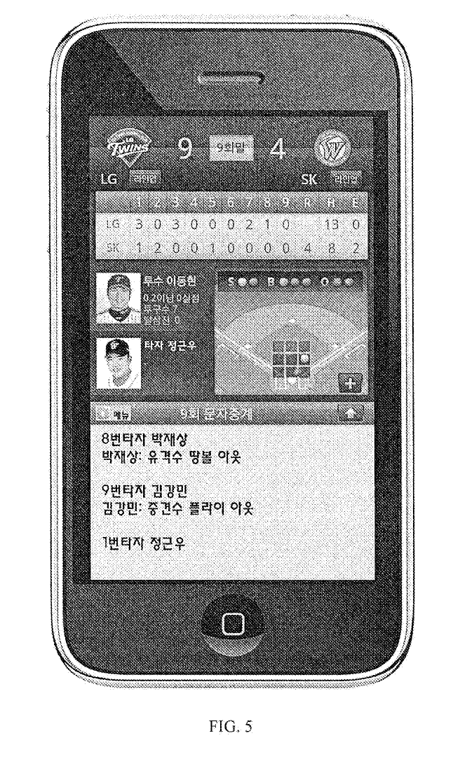

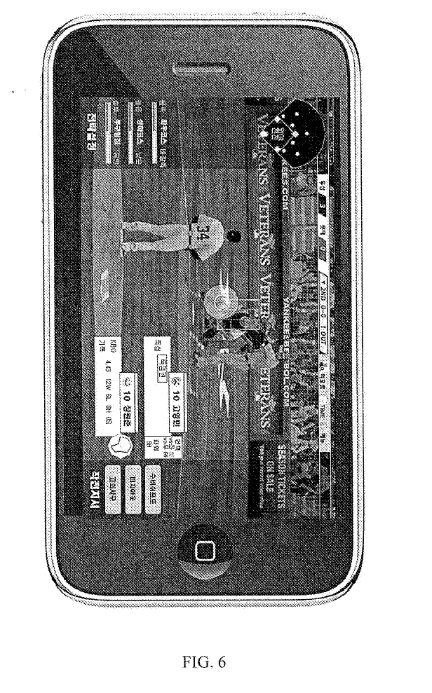

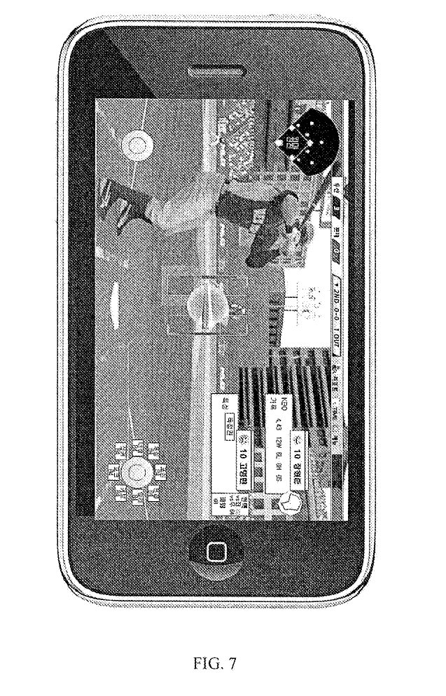

FIG. 5 a view showing a picture captured from a game screen when an owner mode is selected, FIG. 6 a view showing a picture captured from a game screen when a manager mode is selected, and FIG. 7 a view showing a picture captured from a game screen when a player mode is selected.

In the owner mode, information on a game (opponent team, inning, current runs, pitcher, batter, recent progress information or the like) is displayed on the touch screen 102 as text or graphic, and the current situation of the game is transferred to the user in real-time. Then, details of the game are automatically progressed by the game progress module 302.

In the manager mode, a further specific game screen is displayed, and the game screen provides buttons capable of previously selecting a motion although they do not directly control the motions of the players.

In the player mode, a direction control window for selecting a course of pitching a ball by a pitcher and a direction control window selecting a ball to hit by a batter are separately displayed. In addition, a virtual joystick for selecting a ball type is also displayed.

After the batter hits the ball, a window for controlling fielders is displayed for a defending team, and a window for handling motions of runners is displayed for an offending team.

As described above, a user may automatically progress a baseball game or manually handle a baseball game, while viewing a screen corresponding to each mode.

According to the present invention, when a user enjoys a baseball game using a mobile terminal such as a smart phone, the user may enjoy the game in an appropriate way according to a situation of the user, and interest of the user may be increased since the degree of intervention of the user in controlling a game can be adjusted.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of progressing a mobile baseball game capable of changing a game mode, which is a degree of intervention of a user in the baseball game progressed by a game server, as a method of progressing the baseball game allowing the user to select the game mode, the method comprising:
a first step of connecting to the game server through an Internet, by a user terminal, when the user executes a baseball game application installed in the user terminal;
a second step of displaying a setup window for changing the game mode on a touch screen, by the user terminal, when the baseball game is started or the user presses a menu button 106 on the touch screen in order to change the game mode;
a third step of transmitting a game mode selection signal having information on the game mode selected by the user, by the user terminal, when the user selects any one game mode among an owner mode, a manager mode and a player mode from the setup window;
a fourth step of grasping information on the game mode selected by the user from the game mode selection signal and transferring the information to a game progress module, by a game mode change module included in the game server; and
a fifth step of progressing the baseball game according to the game mode selected by the user and displaying a result of the baseball game on the user terminal, by the game progress module.

2. The method according to claim 1, wherein if the user selects the manager mode, the game progress module virtually simulates pitching of a pitcher, hitting of a batter, running of a runner on a base and a motion of a fielder when the batter hits a ball according to an AI algorithm, and
if the user selects the owner mode, the game progress module virtually simulates pitching of a pitcher, hitting of a batter, running of a runner on a base, a motion of a fielder when the batter hits a ball, setting a strategy and directing a tactic according to the AI algorithm.

3. The method according to claim 2, wherein setting a strategy includes determining substitution of a pitcher, use of a pinch hitter or adjustment of a fielding position and practicing details of the strategy in a virtual baseball game, and
directing a tactic includes playing the game by setting motions of hit-and-run, a sacrifice bunt, a pickoff throw, intentional base on balls and base-stealing.

4. The method according to claim 2, wherein if the user selects the player mode, the user controls pitching of a pitcher, hitting of a batter, running of a runner on a base, a motion of a fielder when the batter hits a ball, setting a strategy and directing a tactic using a joystick and buttons.
